(19) United States
(12) Patent Application Publication
(10) Pub. No.: US 2017/0057099 A1
(43) Pub. Date: Mar. 2, 2017

(54) INTERIOR GRASPER

(71) Applicant: Röhm GmbH, Sontheim/Brenz (DE)

(72) Inventors: EDUARD SCHWEIGERT, SYRGENSTEIN (DE); JENS GRÄßLE, HEIDENHEIM (DE)

(21) Appl. No.: 15/252,769

(22) Filed: Aug. 31, 2016

(30) Foreign Application Priority Data
Sep. 1, 2015 (DE) 10 2015 114 582.0

(51) Int. Cl. B25J 15/00

(52) U.S. Cl. CPC B25J 15/0047

(57) ABSTRACT

An interior grasper is described with an actuator that can be adjusted between a clamped position and a released position, and an axially adjustable clamping cone that is allocated to the actuator and that engages a clamping element. The clamping element is formed in one piece with the holding plate and interacts with a tool and/or a work piece.

### CROSS-REFERENCE TO RELATED APPLICATIONS/INCORPORATION BY REFERENCE

This patent application makes reference to, claims priority to, and claims benefit from German Patent Application No. 10 2015 114 582.0, filed on Sep. 1, 2015. The above-identified application is hereby incorporated by reference herein in its entirety.

### FIELD OF THE DISCLOSURE

Some embodiments of the present disclosure relate to an interior grasper that grasps the interior contour of a tool, a work piece, or the like. Some embodiments of the present disclosure provide that interior graspers are used in handling technology which is used with and/or is part of, for example, positioning systems and so-called pick-and-place applications. Some embodiments of the present disclosure provide that interior graspers can be used with robots.

### BACKGROUND

Limitations and disadvantages of conventional and traditional approaches will become apparent to one of skill in the art, through comparison of such systems with the present disclosure as set forth in the remainder of the present application with reference to the drawings.

### BRIEF SUMMARY

Systems, devices, and methods that provide an interior grasper are provided, substantially as illustrated by and/or described in connection with at least one of the figures, as set forth more completely in the claims.

### BRIEF DESCRIPTION OF THE DRAWINGS

FIG. 1 shows a longitudinal cross-section through an embodiment of an interior grasper according to the present disclosure.

FIG. 2 shows a perspective view of the grasper shown in FIG. 1.

### DETAILED DESCRIPTION

Internal graspers can be costly since they are formed from a plurality of individual components. The production of large quantities of such graspers can also be disadvantageously subject to long processing periods.

Some embodiments of the present disclosure provide a simplified interior grasper.

Some embodiments of the present disclosure provide an interior grasper that includes an actuator which can be adjusted at least between a clamped position and a released position, where an axially adjustable clamping cone is allocated to the actuator. This clamping cone engages a clamping element, which can interact with a tool and/or a work piece and which is formed in one piece with a holding plate. Therefore, the actuator serves to adjust the interior grasper, which can be realized particularly as a cylinder operated as a pressure mechanism. Because the holding plate is formed in one piece with the clamping element, it can be produced in a single production step in order to subsequently be connected to the actuator.

It has proven beneficial in some embodiments of the present disclosure that the holding plate is produced with the clamping element using a generative production (e.g., additive manufacturing) process. In some embodiments, a powder-bed method is used, such as selective laser melting (SLM) or selective laser sintering (SLS). Furthermore, the holding plate can also be produced with the clamping element in a free-room method, such as fused deposition modeling (molten layering) or laminated object manufacturing (LOM), or also produced by cold gas injection or by electron beam melting. Furthermore, liquid material methods may be used for the production of the holding plate with the clamping element, e.g., by stereo-lithography (SLA), digital light processing (DLP), or liquid composite molding (LCM).

In some embodiments of the present disclosure, it has proven advantageous to couple the actuator to the holding plate such that the clamping element is radially spread in the clamping configuration by the clamping cone. Thus, a clamping cone is provided to radially expand the clamping element interacting with the tool or the work piece to clamp an interior contour. Due to the generative production (e.g., additive manufacturing) method, it is possible to produce any complex contour and to precisely adapt the clamping element to the work piece or tool to be grasped.

Some embodiments of the present disclosure provide that the clamping element is formed in one piece from a coupling section connected to the holding plate; a conical section formed with an interior cone; and an end section tapering at the exterior circumference. The coupling section connects the holding plate to the clamping element. The conical section can be the section of the clamping element that interacts with the clamping cone of the actuator. A tapering end section facilitates the insertion of the clamping element into an interior contour of a tool and/or work piece to be grasped. It is at the tapering end section that an automatic alignment of the tool and/or work piece can occur.

Furthermore, it has proven advantageous for some embodiments of the clamping element according to the present disclosure to be provided at its exterior circumference with a groove, in which a radially acting return element is inserted or arranged. In the clamped position, the clamping cone is positioned such that it radially expands the clamping element. When the actuator is adjusted back into the released position, the clamping element is converted into the released configuration, which is additionally assisted by the radially acting return element. Thus, a return force is provided based on the material or structure of the clamping element and is further supported or amplified by the additional return force of the radially acting return element, thereby achieving an even more defined adjustment of the clamping element.

Some embodiments of the present disclosure provide that the return element is formed as an O-ring or an elastic string.

To increase the elasticity of the clamping element, some embodiments of the clamping element according to the present disclosure provide one or more radially oriented slots.

Because some embodiments of the present disclosure provide that the clamping element is integrally formed with the holding plate in a generative production (e.g., additive manufacturing) method, the holding plate can have a complex structure. For example, the holding plate can benefit from having at least one guide section. The guide section facilitates the positioning of the holding plate and thus the interior grasper, for example, at a robot arm or the like.

To allow for a secure connection between the holding plate and the actuator, some embodiments of the holding plate according to the present disclosure include at least one bore hole, into which is inserted into a fastener that is configured to connect the holding plate to the actuator.

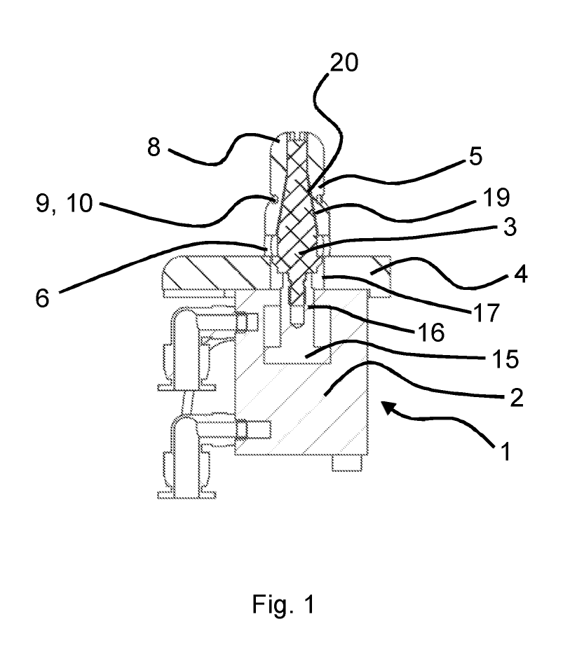

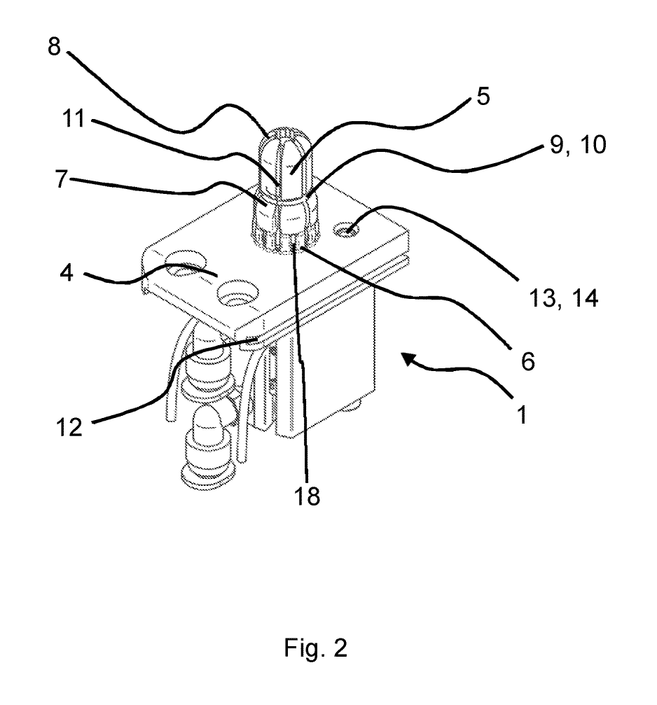

FIGS. 1 and 2 show an interior grasper 1 with an actuator 2. Some embodiments provide that the actuator 2 is formed as a clamping cylinder actuated by a fluid in which a piston 15 is guided adjustably in the axial direction. A tie rod or push rod 16 is fastened at this piston 15, which in turn is connected to the clamping cone 3. For this purpose, the clamping cone 3 includes a threaded section with an exterior thread, which is screwed into an internal thread of the tie rod 16. The clamping cone 3 provides a conical or tapered exterior contour which narrows in the exemplary embodiment on the side facing away from the actuator 2. In other words, the clamping cone 3 provides an exterior cone 20. Some embodiments provide that the clamping cone 3 provides for the insertion of an exterior cone 20 tapering in the direction of the actuator 2, through which, by a tensile actuation, the work piece is clamped. Therefore, by the actuator 2, the clamping cone 3 is supported in an axially adjustable fashion and can also be adjusted between a clamped position and a released position.

Some embodiments of the present disclosure provide a holding plate 4 that is formed in one piece with a clamping element 5. The holding plate 4 provides a passage 17, through which the clamping cone 3 is guided. The clamping cone 3 abuts at an interior wall of the clamping element 5, particularly at an interior cone 19, and is designed to expand the clamping element 5. The holding plate 4 is coupled to the actuator 2 such that the clamping element 5 is expanded or spread radially in the clamped configuration by the clamping cone 3. For this purpose, the conical exterior contour of the clamping cone 3 is made to interact with an interior contour of the clamping element 5, also shown as conical in shape in an exemplary embodiment. Referring to FIG. 1 and in accordance with an embodiment of the present disclosure, when the piston 15 is displaced axially in the direction of the holding plate 4, an expansion of the clamping element 5 by the clamping cone 3 results, allowing a work piece and/or a tool to be grasped at the inside. When the piston 15 is adjusted in the opposite direction, based on the material elasticity of the clamping element 5, it is again brought into the initial position shown in FIG. 1. In order to support the return of the clamping element 5 into the released position as shown in FIG. 1, the clamping element 5 provides a groove 9 at an exterior perimeter. A return element 10 is inserted into groove 9, which acts radially upon the clamping element 5. This return element 10 is configured as an O-ring in an exemplary embodiment.

Referring to FIG. 2, an exemplary embodiment of the clamping element 5 is formed with radially oriented slots 11, increasing the elasticity of the clamping element 5. These slots 11 can also be filled with a material, for example, an elastomer. Alternatively, the clamping element 5 can also be formed in a closed fashion. As shown in FIG. 2, an exemplary embodiment of the clamping element 5 is divided into several sections, in particular, three sections, for example. The three sections include a coupling section 6, a conical section 7, and a tapering end section 8. The coupling section 6 is connected to a holding plate 4. A conical section 7 is formed with the interior cone 19. The tapering end section 8 narrows at the exterior perimeter.

As shown in FIG. 2, the coupling section 6 is formed with additional recesses 18, by which it is configured in an axially compressible fashion according to some embodiments of the present disclosure. This serves to release a tool or work piece. When the clamping cone 3 is axially adjusted in the direction of the actuator 2, based on the friction between the interior cone 19 and the exterior cone 20, it axially entrains or draws in the clamping element 5, causing the coupling section 6 to be axially compressed. This way the clamped work piece is made to contact the area of the holding plate 4 (unless this is already the case). If the clamping cone 3 is adjusted further, it still entrains or draws in the clamping element 5 by compressing the coupling section 6, thereby causing the holding plate 4 to push away the work piece (at the facial side) from the clamping cone 3. The work piece is therefore easily released.

Some embodiments of the present disclosure provide that the holding plate 4 provides guide sections 12 that allow the holding plate 4 to be easily fastened at the desired device (e.g., to a robot arm). Further, in order to connect the holding plate 4 to the actuator 2, the holding plate 4 can be configured or equipped with bore holes 13, in which a fastener 14 can be inserted.

In sum, some embodiments of the interior grasper 1 can be characterized by its compact design and the fact that its production is subject only to short processing periods because the holding plate 4 and the clamping element 5 are produced in one piece in a single processing step.

List of reference characters

| | |
|---|---|
| 1 | Interior grasper |
| 2 | Actuator |
| 3 | Clamping cone |
| 4 | Holding plate |
| 5 | Clamping element |
| 6 | Coupling section |
| 7 | Conical section |
| 8 | End section |
| 9 | Groove |
| 10 | Return element |
| 11 | Slot |
| 12 | Guide section |
| 13 | Bore hole |
| 14 | Fastener |
| 15 | Piston |
| 16 | Tie rod and/or pressure rod |
| 17 | Passage |
| 18 | Recess |
| 19 | Internal cone |
| 20 | External cone |

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. An interior grasper, comprising:
an actuator that is adjustable at least between a clamped position and a released position,
wherein the actuator includes a clamping cone, and
wherein the clamping cone engages a clamping element that is configured as a single piece with a holding plate and that is configured to interact with a tool or a work piece.

2. The interior grasper of claim 1, wherein the clamping element is configured to grasp an interior of the tool or the work piece.

3. The interior grasper of claim 1, wherein the clamping cone is an axially adjustable clamping cone.

4. The interior grasper of claim 1, wherein the clamping element is configured to be radially spread by the clamping cone when the actuator is moved to the clamped position.

5. The interior grasper of claim 1, wherein the actuator is operatively coupled to the holding plate.

6. The interior grasper of claim 1, wherein the clamping element and the holding plate are formed as a single piece by a generative or additive manufacturing process.

7. The interior grasper of claim 1, wherein the clamping element is formed in one piece that includes a coupling section, a conical section, and an end section.

8. The interior grasper of claim 7, wherein the coupling section is connected to the holding plate.

9. The interior grasper of claim 7, wherein the end section is configured to taper at an exterior circumference.

10. The interior grasper of claim 7, wherein the clamping element is formed in one piece using a generative or additive manufacturing process.

11. The interior grasper of claim 1, wherein the clamping element is configured to provide, at an exterior circumference, a groove in which a radially acting return element can be inserted or arranged.

12. The interior grasper of claim 11, wherein the return element is configured as an O-ring or an elastic string.

13. The interior grasper of claim 1, wherein the clamping element is configured with radially oriented slots.

14. The interior grasper of claim 1, wherein the holding plate includes at least one guide section.

15. The interior grasper of claim 14, wherein the holding plate is fastened to a robot arm via the at least one guide section.

16. The interior grasper of claim 1, wherein the holding plate includes at least one bore hole configured to receive a fastener that connects the holding plate to the actuator.
